(19) United States
(12) Patent Application Publication
(10) Pub. No.: US 2009/0255098 A1
(43) Pub. Date: Oct. 15, 2009

(54) CLAMP WITH A NON-LINEAR BIASING MEMBER

(76) Inventors: John William Andberg, Santa Cruz, CA (US); Donald Wai-Chung Chiu, Santa Clara, CA (US)

Correspondence Address: Gregory W. Osterloth;Holland & Hart, LLP, P.O. Box 8749, Denver, CO, 80201, US

(21) Appl. No.: 12/101,807

(22) Filed: Apr. 11, 2008

(51) Int. Cl. F16B 2/02

(52) U.S. Cl. 24/530

(57) ABSTRACT

In an embodiment, there is disclosed a clamp, having a housing; a latch member extending from within the housing, and the latch member translatable along a displacement axis; an actuator mounted to the housing and operatively associated with the latch member to translate the latch member along the displacement axis; and a nonlinear biasing member operatively associated with the latch member and the housing, and the nonlinear biasing member positioned to bias the latch member toward a retracted position. Other embodiments are also disclosed.

### BACKGROUND

In many manufacturing operations, newly manufactured parts need to be tested to ensure that the new parts have been manufactured according to the design specifications and to ensure that the new parts perform as expected under specific test conditions. A wide variety of test equipment and instrumentation is utilized to test such newly manufactured parts.

When testing such parts, it is often necessary to securely hold or clamp the newly manufactured parts to test apparatus for a short period of testing. For example, in the electronics industry, an electronic device will need to be clamped to a tester so that the tester can test the electronic device. The clamping must be accomplished in such a way as to allow various probes on the tester to reliably contact various circuit nodes and contacts provided on the electronic device. Testing operations can be enhanced by clamping systems that can quickly and accurately clamp and release the electronic device to be tested.

### SUMMARY OF THE INVENTION

In an embodiment, there is provided a clamp, comprising a housing; a latch member extending from within the housing, and the latch member translatable along a displacement axis; an actuator mounted to the housing and operatively associated with the latch member to translate the latch member along the displacement axis; and a nonlinear biasing member operatively associated with the latch member and the housing, and the nonlinear biasing member positioned to bias the latch member toward a retracted position.

In another embodiment, there is provided a clamp, comprising a housing; a latch member extending from within the housing, and the latch member translatable along a displacement axis; an actuator mounted to the housing and operatively associated with the latch member to translate the latch member along the displacement axis; a biasing member operatively associated with the latch member and the housing, and the biasing member positioned to bias the latch member toward a retracted position; and a first guide and a second guide adjacent the latch member, and the first guide and the second guide positioned to maintain linear translation of the latch member along a displacement axis and inhibit translation of the latch member outside of the displacement axis.

In yet another embodiment, there is provided a method of operating a clamp, comprising activating an actuator to cause a latch member to translate along a displacement axis toward an extended position against a biasing force applied by a nonlinear biasing member; engaging a clamp end of the latch member with a component to be clamped; and deactivating the actuator to allow the biasing force of the nonlinear biasing member to cause the latch member to translate along the displacement path toward a retracted position.

Other embodiments are also disclosed.

### BRIEF DESCRIPTION OF THE DRAWINGS

Illustrative embodiments of the invention are illustrated in the drawings, in which:

FIG. 1 illustrates an interposer interconnect;

FIG. 2 illustrates a double acting pneumatic cylinder having a first inlet on one side of a flange and a second inlet on another side of the flange;

FIG. 3 illustrates a pneumatically activated clamp with a preloaded biasing member configured to urge the flange end of the latch away from the clamping end of the cylinder;

FIG. 4 illustrates a pneumatic clamp;

FIG. 5 illustrates a force versus displacement graph for a linear biasing member, and nonlinear biasing members;

FIG. 6 illustrates an exemplary embodiment of a Belleville washer;

FIG. 7 illustrates a force versus deflection graph for various height/thickness ratios for Belleville washers;

FIG. 8 illustrates a force versus deflection curve for a clover spring;

FIG. 9 illustrates a clamp having nonlinear softening biasing members;

FIG. 10 illustrates an exploded view of the clamp shown in FIG. 9; and

FIG. 11 illustrates a cross-sectional view of the clamp shown in FIGS. 9 and 10.

### DETAILED DESCRIPTION

In the last few years, testers for memory products (e.g., DRAM and Flash products) have undergone great changes. Memory speed and density have increased by multiple orders of magnitude, and the testers have followed suit. However, as speeds increased, signal path length has become a critical issue. Minimizing path length to achieve high speeds has led to miniaturization of tester components by a factor of over 1000 in the last 5 years.

A general overview of the equipment related to tester equipment may include the following components. A system bay is an upright rack mount which houses the support devices for the test head. In a typical system, the system bay houses the cooling unit, power supplies and controller for the test electronics. Large bundles of electrical cables and cooling water hoses connect this system bay to the test head. The test head is a relatively small enclosure that houses all the tester electronics. The actual signal generation and analysis are performed in the test head. Attached to the test head is the interface. This is an electromechanical assembly that is basically a very large connector, which allows various probe cards to be attached to the tester. It is the probe card that actually contacts the wafer and makes electrical contact with the metallic pads on the wafers surface.

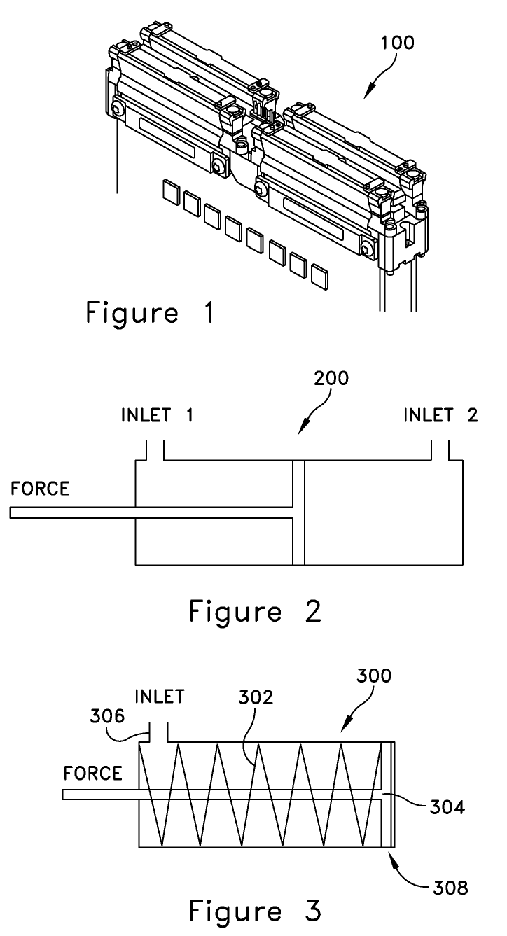

As new and cost effective solutions are developed for the ATE industry, there are larger equipment (i.e., more parallelism.) In an upcoming generation of testers, it will be possible to test over 1000 devices at a time. As more devices are tested simultaneously, the physical size of the test system typically becomes a problem. Although the overall size may increase somewhat, the density of interconnects between the device and the tester increases much more significantly. This results in mechanical aspects of the interconnect that must shrink with increasing density inasmuch as signal path and routing considerations limit the shrinkage of the electrical systems. This becomes the greatest problem in the interface, the part of the tester where the interconnect to a probe card is formed. In an upcoming generation machine, approximately 74000 interconnects need to be made and broken simultaneously. The actual interconnects may be accomplished using an interposer, which includes many small springs in a plastic housing. When mechanical force is applied to the sandwich of PCB-interposer-probe card, this spring provides a low resistance path. The springs are generally at a relatively fine pitch (often 1 mm) in a 2-D array. In one embodiment, there may be from about 500 connector springs in a single plastic housing. This type of interconnect is desirable because the PCBs on either side are relatively robust, and if the interposer is damaged it may easily be replaced. FIG. 1 illustrates an interposer interconnect 100 from the Verigy 5500 Matrix tester. Interposer interconnects and other similar systems may include similar clamping and other applications of mechanical force. Some applications, such as the WSI-2 may include less free space, and may include a radial configuration, which generally makes force application very difficult.

A method of force application may include a pneumatically actuated clamp. Each clamp unit may be relatively small, and may provide limited force. However, by providing enough of these units, which should be suitably distributed, the necessary clamping force may be achieved. In an embodiment, the clamp may include two significant features. One of these features is a relatively small cross section so as to allow the clamp to fit between interposers. As the clamp device will clamp a probe card to a tester device, another feature is the clamp device must be configured to not open unexpectedly. Probe cards of the complexity necessary for testing purposes are very expensive and delicate. A probe card's cost may exceed $250,000. On a probe card there are typically tens-of-thousands of needle like contacts extend outward to touch a wafer. Any non-vertical force may easily destroys the contacts. In addition, overdriving the contacts by only a few thousandths of an inch may also destroy the contacts. It is thus imperative that the clamp used to hold the probe card to the interface must be precise in operation with no failure that may allow it unexpected opening. Such opening may allow the probe card to drop, and cause the prober, which is the machine that positions a wafer to the probe card, to damage the probe card.

It is a common task in many industries to use pneumatically actuated clamps. As automation has pervaded manufacturing, available clamping devices have increased. Many of these clamps include a simple double acting pneumatic cylinder 200. (See FIG. 2.). As illustrated in FIG. 2, these devices use air pressure on one side to actuate one direction forward inlet 202 and then reverse the connection to actuate to the other direction toward inlet 204. This simplest type of actuator is unsuitable for our use because a failure of air pressure allows the clamp to open.

A clamp actuator 300 (FIG. 3) with a preloaded spring 302 is most suitable for many ATE applications. Clamp actuator single actuating pneumatic cylinder 304 is held in one position by precompressed linear spring 302. These types of clamp actuators 300 are also common industrial devices, and also have had long use in the ATE industry.

Some examples are provided by U.S. Pat. No. 7,213,803 issued to Chiu and U.S. Pat. No. 6,340,895 issued to Uher, et al. The action of device 300 is such that in the fully closed position, spring 302 provides the clamping force. In order to overcome this force, air pressure is applied to the cylinder through inlet 306. When the force provided by the air exceeds the spring force, clamp 300 begins to open. The problem with this type of device starts here. It should be appreciated that the force to compress a spring is a linear function of distance. Because of this, the air provided by inlet 306 must apply more and more force to further open clamp 300. In many situations, as much as twice the clamping force must be applied to fully open clamp 300. This becomes even more of a problem if the geometry of clamp 300 is shorter and has a smaller diameter. With a shorter clamp 300, spring 302 must compress a greater fraction of its length, thus increasing the force to compress spring 302. At the same time, as the diameter decreases, the available force decreases since the area decreases at a distal end 308 of piston 304. Thus, as this type of clamp becomes more miniaturized, it becomes almost useless. These factors limit the usefulness of clamp 300 in the ATE industry.

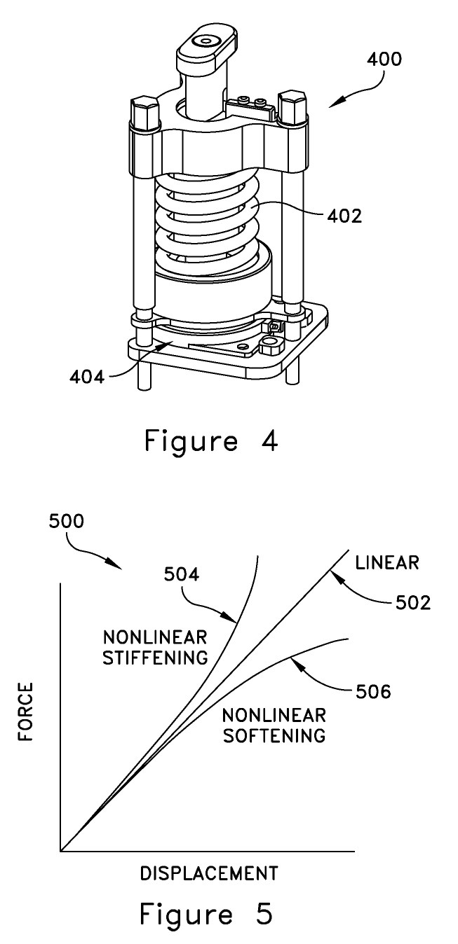

Referring now to FIG. 4, clamp 400, which is generally configured to hold the Final Test Interface to the Matrix unit of model V5500, is based on a relatively large coil spring 402. Clamp 400 may include overall dimensions of 5.25″ tall and 4″ diameter. This is far too large for many newer tester applications. Spring 402 used in this clamp has a 3.5″ free length, a 1.94″ OD, 0.25″ wire diameter, and has a spring rate of 198 lb/in. For this use, clamping force is 110 lb, so spring 402 is compressed to 2.94″, with a spring compression of 0.55″. In an embodiment, clamp 1100 travels 0.25 inches from the closed to the open position. In the fully open position, the force required to displace the spring is to the stop is approximately 0.8*198=158 lb. This is the force that must be produced by pneumatic actuator 404 to open clamp 400. In general, this is acceptable since the clamp can contain a piston that is 2″ diameter. A piston of this size can produce about 267 lb at an air pressure of about 85 psi.

As the dimensions of clamp 400 are made smaller, the force to open becomes excessive in comparison to the force available from a piston of a similar spring diameter. If the length of clamp 400 is reduced to 1.5 inches, and the diameter of spring 1102 diameter to 1.4 inch, an acceptable choice of spring is the Century Spring 72767. This spring has a 1.4″ diameter, a 2.5″ free length, a wire diameter 0.162″, and a spring rate of 103 lb/inch. Clamp 400 has a clamping force of 110 lb when spring 402 is compressed to 1.43″. For a clamp travel of the same 0.25″, the length of spring 402 becomes 1.18″, and the force to open is 135 lb. Note that a 1.4″ diameter piston will only produce 130 lb, so this clamp will not be able to fully open.

The basic deficiency is the nature of a plain spring, in that the force of deflection is proportional to the deflection, as illustrated in FIG. 5. Smaller springs must be made with smaller diameter wire. Thus, these smaller springs have lower spring rates. To have a small spring provide sufficient force, it must be compressed a large proportion of its free length. The additional spring deflection required by the clamp opening proportionately adds to the force, and, in many cases, exceeds the force that may be supplied by a matching sized air cylinder.

In an embodiment, difficulties may be ameliorated by using a spring device with characteristics better suited to the task. As stated previously, the common compression coil spring has a force directly proportional to deflection shown on graph 500 by a plot 502, and is generally known as a linear spring. There are other types of springs, which are nonlinear in their deflection. One type deflection is referred nonlinear stiffening, which may be caused by a nonlinear stiffening spring, and is shown as a plot 504. A nonlinear stiffening spring may have coils that are designed to touch as the spring is compressed. This configuration causes the spring constant to increase with deflection. This behavior is also illustrated in FIG. 5. Another type of spring is referred to as a nonlinear softening spring, shown in FIG. 5 by a plot 506. One example of this type of nonlinear softening is a compound bow for archery. As it is drawn back, the spring force decreases with deflection, which makes it easier to hold the bow in the cocked position. Note that in this case, this type of action is obtained by a complicated system of pulleys and cables, which is not an option for a clamp used in a small area.

Other nonlinear softening springs have been described using a polymer cylinder of suitably tailored materials and interior features. This configuration is too complicated for use in a small area of an ATE system.

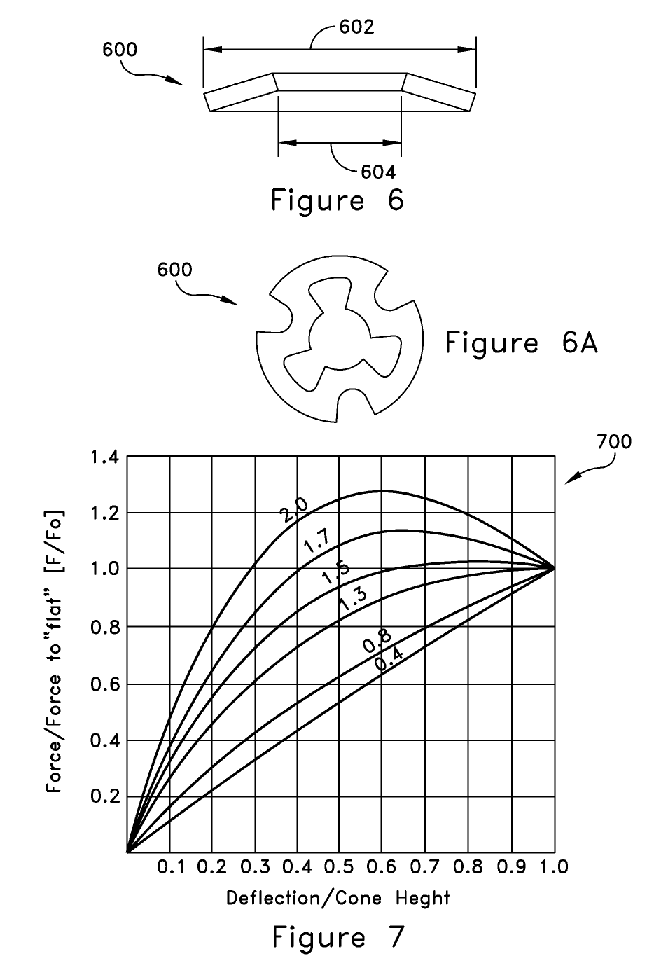

A last example of a softening nonlinear spring is one chosen for use in a small area of an ATE system. Certain types of Belleville washers exhibit this type of behavior. A Belleville spring or washer 600 (FIG. 6) is a type of disk spring. A sheet of thin spring material, which is usually high carbon steel, is punched out to create a washer of large outer diameter (OD) 602 and small inner diameter (ID) 604. This washer may next be stamped to dome it to a truncated cone shape. After hardening, this forms Belleville spring 600. FIG. 6 illustrates Belleville spring 600 in a cross section view. In general, these types of springs are very stiff (i.e., very small deflections produce very large forces). One common use of Belleview springs is under large bolts in structural applications to provide compressive force even if bolts loosen slightly due to vibration or thermal effects.

One important characteristic of Belleville washers is the force versus deflection curve may be nonlinear for some washer geometries. As illustrated in graphical representation 700 of FIG. 7, as the height versus material thickness becomes greater than 0.4, the curve exhibits the behavior of a softening nonlinear spring. As this ratio becomes greater than 1.5, this behavior is very pronounced. At the highest ratios illustrated (e.g., 2.0 and above) the washers may actually invert under loading.

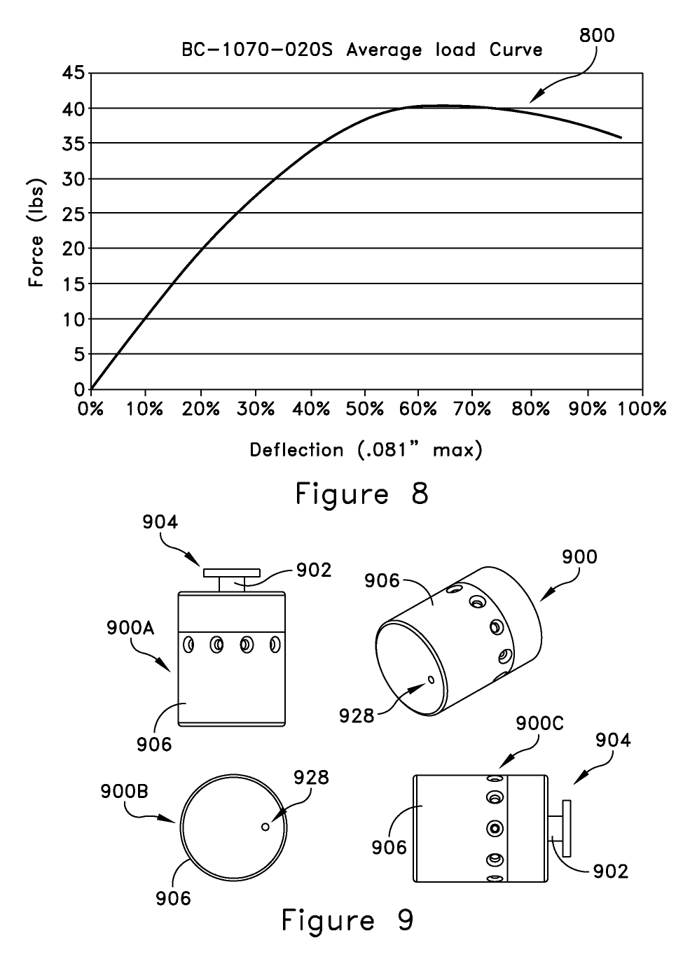

This softening nonlinear behavior allows a pneumatic clamp to be miniaturized. FIG. 8 illustrates the force versus deflection curve 800 for a Clover Spring BC-1070-020S Belleville washer. The Clover spring is one type of Belleville washer that has cutout sections around the inner and outer perimeter to allow greater deflection at lower loadings than a standard Belleville shape. This washer has an OD of 1.069″ and an ID of 0.4″. Its unloaded height is 0.101″ and the thickness of the disk material is 0.02″. Its ratio of height to thickness is greater than 4, so it has a pronounced softening behavior. It is generally known that Belleville springs should not be compressed past 75% of their total deflection. Otherwise, overcompression may cause fatigue failures to occur at low numbers of cycles.

Belleville washers also have one very handy characteristic that normal wire springs do not. That is that their deflection and loading can be tailored to some extent by stacking washers in a specified manner. For a single washer, the force at a given deflection may be looked up or measured. If more force is needed, then the washers may be stacked in the same direction to increase the overall force created by deflections of the washers. If, on the other hand, a greater deflection is needed at a given force, multiple washers may be stacked in opposing directions to accomplish this.

In one embodiment, a washer may be used with a nominal force of 37 lbs. at a deflection of 0.038″. A clamp may use groups of 3 washers so as to create a total load of 111 lbs. at a deflection of 0.038″. This group of 3 washers is 0.103″ in height when loaded. Such a clamp may use 15 opposed pairs of 3 washers so as to achieve the necessary total deflection of 0.25″. This creates a total height of 1.54″, and each group deflects an additional 0.0167″ for the total deflection. From the load versus deflection curve, this deflection occurs at a load of 40 lbs. per washer, or a total of 120 lbs. for the stack. This is a much lower load at the maximum deflection than could ever be accomplished with a linear wire spring. The clamp diameter is related to the force necessary to fully deflect the stack. For the 120 lb. force, at a pressure of 85 psi the necessary piston diameter is 1.35″, making for a very compact design.

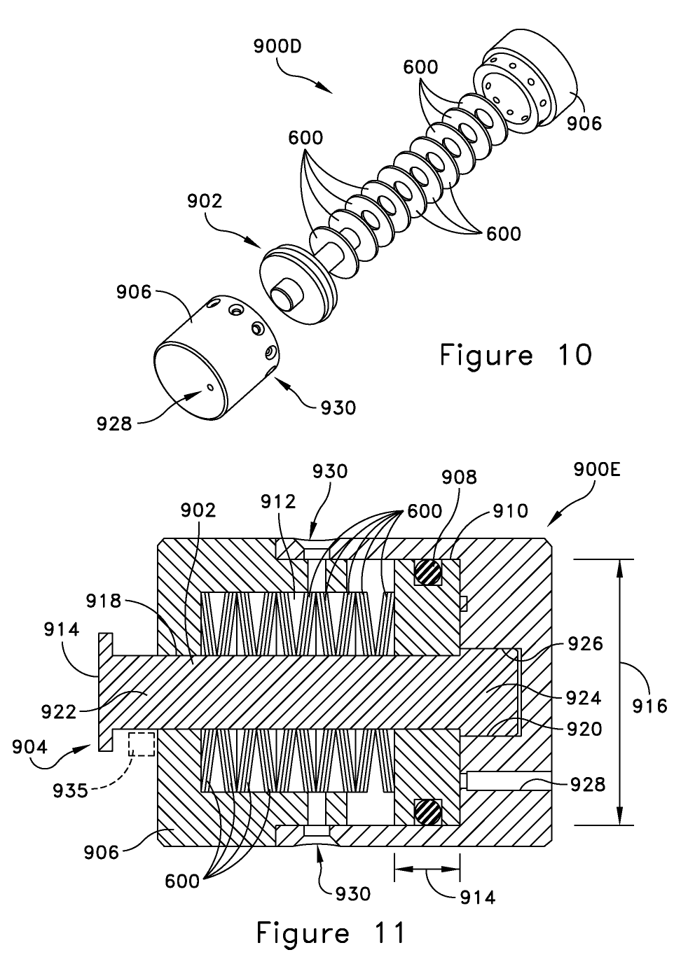

An exemplary embodiment of a clamp 900 is shown in FIGS. 9-11. Additional views are shown as clamps 900A, 900B, and 900C in FIG. 9, along with an exploded view shown as claim 900D in FIG. 10. Referring now to FIG. 11, there is shown a cross-sectional illustration of clamp 900E. In an embodiment, a piston rod 902 forms a latch member 904 extending from within a housing 906 (or cylinder 906). Piston head 910 engaging housing 906 may include an 0-ring seal 908. A washer stack 912 of nonlinear biasing members 600, such as Belleville springs 600 or Clover springs 600, is situated above piston head 902, forcing end 914 of latch member 904 to the lowest possible position when air pressure is not applied. To allow as compact as possible design, the piston head 910 is pancake shaped, i.e., it is not tall in relation to its diameter. Generally, a piston only can self-center in a bore if it is as tall or high as it is wide. As such, a thin piston head 910 is not usually found on a clamp of this type.

In order to allow the use of a smaller piston head 910 relative to width 916, first and second guides 918 and 920 may be provided adjacent to a piston rod 902 at a top portion 922 and a lower portion 924. The first guide 918 is around piston rod 924 or continuance 924, while the second guide 920 may be configured around an extension 924 of piston rod 924 that extends in a recess 926 in cylinder 906. Air inlet 928 may be provided as an actuator to actuate piston head 910. Screws or other attachment members 930 may also be provided to hold clamp 900 together.

In one embodiment, latch member 904 of clamp 900 may be configured to be selectively rotatable about the displacement axis. This rotation may be provided in order to allow engagement and clamping with the end of latch member 904. For example, an external rotary actuator 935 may be provided in operable connection with latch member 904. In another embodiment, latch member 904 may extend along the displacement axis without rotation, and may be configured for other types of non-rotary engagement.

In an embodiment, nonlinear biasing member 600 may include a softening nonlinear spring 600 configured to provide a decreasing spring force with deflection. This configuration generally allows movement of latch member 904 away from a retracted position near housing 600 with proportionally decreasing additional force from an actuator.

In an exemplary embodiment, there is provided a method of operating a clamp. This method may include activating an actuator to cause a latch member to translate along a displacement axis toward an extended position against a biasing force applied by a nonlinear biasing member. The method may further include engaging a clamp end of the latch member with a component to be clamped. The method may also include deactivating the actuator to allow the biasing force of the nonlinear biasing member to cause the latch member to translate along the displacement path toward a retracted position. In one embodiment, activating the actuator to cause a latch member to translate along the displacement axis toward the extended position against the biasing force applied by the nonlinear biasing member may require proportionally decreasing additional force from the actuator to allow movement of the latch member away from the retracted position as the nonlinear biasing member may include a softening nonlinear spring providing a decreasing additional spring force with deflection.

What is claimed is:

1. A clamp, comprising:
a housing;
a latch member extending from within the housing, and the latch member translatable along a displacement axis;
an actuator mounted to the housing and operatively associated with the latch member to translate the latch member along the displacement axis; and
a nonlinear biasing member operatively associated with the latch member and the housing, and the nonlinear biasing member positioned to bias the latch member toward a retracted position.

2. The clamp of claim 1, wherein the nonlinear biasing member comprises a set of Belleville springs.

3. The clamp of claim 2, wherein the Belleville springs are stacked in a single direction with respect to one another.

4. The clamp of claim 2, wherein adjacent ones of the Belleville springs are stacked in an opposing direction with respect to one another.

5. The clamp of claim 1, wherein the nonlinear biasing member comprises a set of Clover springs.

6. The clamp of claim 5, wherein the Clover springs are stacked in a single direction with respect to one another.

7. The clamp of claim 5, wherein adjacent ones of the Clover springs are stacked in an opposing direction with respect to one another.

8. The clamp of claim 1, wherein the actuator comprises a pneumatic actuator.

9. The clamp of claim 1, further comprising a guide adjacent the latch member, and the guide positioned to maintain linear translation of the latch member along a displacement axis and inhibit translation of the latch member outside of the displacement axis.

10. The clamp of claim 1, further comprising a first guide and a second guide adjacent the latch member, and the first guide and the second guide positioned to maintain linear translation of the latch member along a displacement axis and inhibit translation of the latch member outside of the displacement axis.

11. The clamp of claim 10, wherein the first guide and the second guide are positioned on rod portions extending outwardly from opposed sides of a piston.

12. The clamp of claim 1, wherein the housing is a cylinder.

13. The clamp of claim 1, wherein the latch member is rotatable about the displacement axis.

14. The clamp of claim 1, further comprising an external rotary actuator in operable connection with the latch member.

15. The clamp of claim 1, wherein the nonlinear biasing member is a softening nonlinear spring providing a decreasing spring force with deflection so as to allow movement of the latch member away from the retracted position with proportionally decreasing additional force from the actuator.

16. A clamp, comprising:
a housing;
a latch member extending from within the housing, and the latch member translatable along a displacement axis;
an actuator mounted to the housing and operatively associated with the latch member to translate the latch member along the displacement axis;
a biasing member operatively associated with the latch member and the housing, and the biasing member positioned to bias the latch member toward a retracted position; and
a first guide and a second guide adjacent the latch member, and the first guide and the second guide positioned to maintain linear translation of the latch member along a displacement axis and inhibit translation of the latch member outside of the displacement axis.

17. The clamp of claim 16, wherein the first guide and the second guide are positioned on rod portions extending outwardly from opposed sides of a piston.

18. The clamp of claim 16, wherein the actuator comprises a pneumatic actuator.

19. The clamp of claim 16, wherein the housing is a cylinder.

20. A method of operating a clamp, comprising:
activating an actuator to cause a latch member to translate along a displacement axis toward an extended position against a biasing force applied by a nonlinear biasing member;
engaging a clamp end of the latch member with a component to be clamped; and
deactivating the actuator to allow the biasing force of the nonlinear biasing member to cause the latch member to translate along the displacement path toward a retracted position.

21. The method of claim 20, wherein activating the actuator to cause a latch member to translate along the displacement axis toward the extended position against the biasing force applied by the nonlinear biasing member requires proportionally decreasing additional force from the actuator to allow movement of the latch member away from the retracted position as the nonlinear biasing member is a softening nonlinear spring providing a decreasing additional spring force with deflection.
